(19) United States
(12) Patent Application Publication
(10) Pub. No.: US 2005/0058063 A1
(43) Pub. Date: Mar. 17, 2005

(54) Method and system supporting real-time fail-over of network switches

(75) Inventors: Jinsaku Masuyama, Round Rock, TX (US); Yinglin Yang, Round Rock, TX (US)

Correspondence Address: Michael R. Barre;Baker Botts L.L.P., One Shell Plaza, 910 Louisians, Houston, TX, 77002-4995, US

(73) Assignee: DELL PRODUCTS L.P., Round Rock, TX (US)

(21) Appl. No.: 10/662,833

(22) Filed: Sep. 15, 2003

(51) Int. Cl. H04L 12/26

(52) U.S. Cl. 370/217

(57) ABSTRACT

An example embodiment of a system for providing fail-over between switches in a network may include a switch having a server-side port and a fail-over circuit in communication with the server-side port. The switch may also include a status circuit, in communication with the fail-over circuit. The switch may also include a switch-side port. The status circuit may communicate the link status of the switch-side port to the fail-over circuit. In response to receiving a link status of down for the switch-side port, the fail-over circuit may automatically disable the server-side port. A related system may include more than one switch, and the system may automatically fail-over from a first switch to a second switch, in response to the disablement of the server-side port in the first switch. At least one related method is also described.

### BACKGROUND

As the value and use of information continues to increase, individuals and businesses seek additional ways to process and store information. The options available to users include information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Network switches are one type of information handling system. In one example configuration, a switch may be used to connect a group of servers to other devices in a network. When the network includes numerous devices, it may be beneficial to use a hierarchy of switches to connect the group of servers to the other devices. For instance, a hierarchy of switches may be used to allow hundreds or thousands of personal computers (PCs) to connect to a group of central servers.

Such a configuration may include a first set of switches connected directly to the servers, and one or more intermediate sets of switches connected between the first set of switches and the other devices in the network. In such a network, each switch in the first set would typically include server-side ports and switch-side ports, as well as internal circuitry for forwarding data from the server-side ports to corresponding switch-side ports and vice versa. One or more servers could send and receive data to and from the server-side ports, and other network devices could send and receive data to and from the switch-side ports, for instance via the intermediate switches.

In alternative configurations, switch-side ports might be connected to devices other than switches. Accordingly, switch-side ports may also be referred to as network-side ports or external ports. Server-side ports may also be referred to as local ports or internal ports.

### SUMMARY

The present disclosure describes example embodiments of systems for providing automatic fail-over between switches in a network. One example system may include a switch having a server-side port and a fail-over circuit in communication with the server-side port. The switch may also have a status circuit, in communication with the fail-over circuit. The switch may also include a switch-side port. The status circuit may communicate the link status of the switch-side port to the fail-over circuit. In response to receiving a link status of down for the switch-side port, the fail-over circuit may automatically disable the server-side port.

Another example system may include more than one switch, and the system may automatically fail-over from a first switch to a second switch, in response to the disablement of the server-side port in the first switch. At least one related method is also described.

### BRIEF DESCRIPTION OF THE DRAWINGS

A more complete understanding of various embodiments and advantages thereof may be acquired by referring to the following description taken in conjunction with the accompanying drawings, in which:

FIG. 1 depicts a block diagram of example embodiments of systems with support for automatic fail-over between switches in a network, according to the present disclosure;

FIG. 2 illustrates a block diagram of the systems of FIG. 1 in a fail-over mode;

FIG. 3 depicts a generalized schematic diagram of an example embodiment of a network switch with a fail-over circuit according to FIGS. 1 and 2; and

FIG. 4 depicts a flowchart of an example embodiment of a method for supporting automatic fail-over according to the present disclosure.

### DETAILED DESCRIPTION

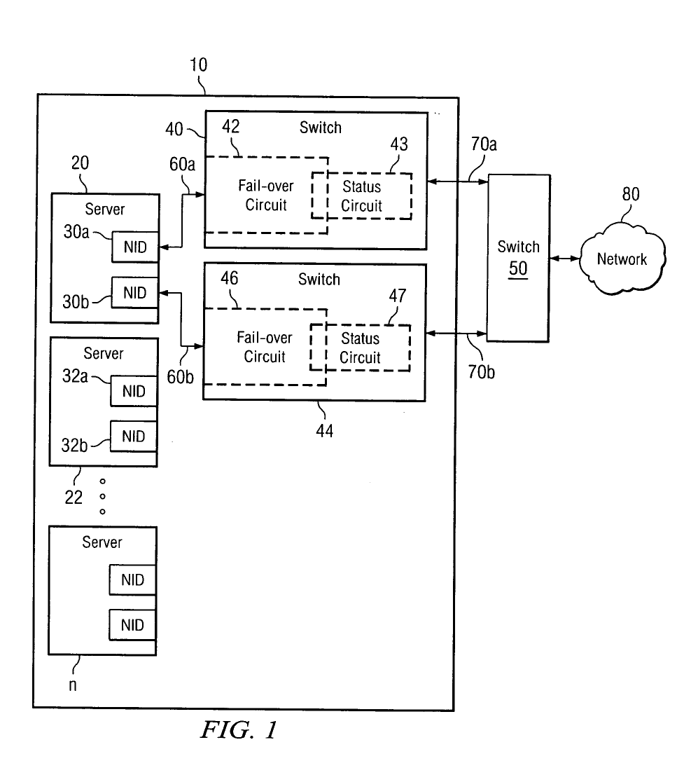

Preferred embodiments and their advantages may be understood by reference to FIGS. 1 through 4, wherein like numbers are used to indicate like or corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices, as well as various input and output (I/O) devices, such as a keyboard, a mouse, and a video display. The information handling system may also include one or more buses operable to transmit communications between the various hardware components.

Thus, the types of systems that may be referred to as information handling systems include, without limitation, individual devices such as network switches and server computers, as well as collections of components that cooperate to handle data, such as an aggregation servers and switches, for example.

As mentioned above, a group of servers may be connected to a network via multiple switches. One popular product used in such environments is the server blade system marketed by Dell under the PowerEdge trademark. For example, a PowerEdge (PE) 1655MC server blade system may integrate up to six server blades, two Ethernet switch modules, and an embedded remote management module into a highly dense, highly integrated 3U enclosure.

One of the most important challenges facing network managers is to minimize network downtime. One technique used to minimize downtime is to provide redundant resources, with either manual or automatic fail-over from one resource to another.

For instance, multiple servers may be connected to a network via redundant switches. According to the “Hot Standby Router Protocol” (HSRP) approach implemented by Cisco Systems, fail-over in such an environment may be supported through use of probe packets that are periodically transmitted to detect component failure. One disadvantages of such an approach, however, is the latency between the time that failure occurs and the time that a probe packet is transmitted and failure detected. Another disadvantage is that network bandwidth is consumed by the probe packets. In addition, approaches like HSRP may be limited in application to devices of only a single vendor.

Another approach for providing network redundancy between servers and switches is known as virtual team technology. For instance, Broadcom markets a technology known as Smart Load Balancing (SLB) for enabling bi-directional load balancing of IP traffic across multiple virtual team members. The virtual team members may be network interface devices (NIDs), such as network interface cards (NICs) or LAN-on-motherboard (LOM), and SLB may provide some support for redundancy and automatic fail-over between virtual team members. For instance, a system with SLB may be configured to group specific NIDs into a virtual team, and SLB may drive the system to automatically fail-over from one NID to another in response to detecting link loss on the first NID.

One significant limitation to SLB technology, however, is that the teamed NIDs only detect the local link signals (i.e., the link signals for the connection between the NIDs and the server-side ports) for fail-over. Consequently, if link is lost on the network side (e.g., because of a cable break between the local switch and an external switch), the virtual team may not detect the external link loss. Consequently, SLB may not trigger fail-over, and traffic may be interrupted.

Another limitation is that, when a switch is rebooted, a NID connected to that switch may not detect link loss on the local link. Consequently, when the virtual team is configured and network traffic is running, the system may not trigger fail-over when a switch is rebooted, and the network traffic could therefore be interrupted.

With reference now to FIG. 1, in one example embodiment, server 20, server 22, up to server n may represent server blades in a server system 10, such as a PE1655MC server blade system. Switches 40 and 44 may represent switch blades in that system 10. Switches 40 and 44 may therefore also be referred to as internal or local switches 40 and 44. Switch 50 may be referred to as an external, remote, or intermediate switch 50. Server 20, server 22, up to server n may connect to network 80 via internal switches 40 and 44 and one or more intermediate switches 50.

Thus, switch 40, for example, may include one or more server-side ports for communicating with one or more of server 20, server 22, up to server n, as well as one or more switch-side ports for communicating with external or remote devices such as remote switch 50. Switch 40 may also include internal circuitry for forwarding data from the server-side ports to corresponding switch-side ports and vice versa. Switch 44 may include identical or similar features to switch 40.

Each server may include multiple NIDs for purposes such as fail-over, redundancy, and/or load balancing. For instance, server 20 may include NID 30a and NID 30b, and server 22 may include NID 32a and 32b. To support switch redundancy, server system 10 may be configured to logically group NIDs 30a and 30b into a virtual team, with NID 30a connected to switch 40 and NID 30b connected to switch 44. The other servers may be connected to switches 40 and 44 similarly.

The communication paths between the servers and the switches, such as communication paths 60a and 60b, may be referred to as internal or local links 60a and 60b. Communication paths such as the one between switch 40 and switch 50 may be referred to as remote, external, or network links, such as network links 70a and 70b. Network links 70a and 70b may also be referred to as uplinks 70a and 70b. Local links 60a and 60b may also be referred to as downlinks 60a and 60b.

For purposes of this disclosure, the term “link loss” refers to a state of a communication path between two ports in which signals fail to effectively travel between those two ports. Thus, if a cable for uplink 70a were to be break, there would be link loss at the corresponding switch-side port of switch 40. Link loss may also be described in terms of a link status of “down” or “bad.” Conversely, if the communication path is operational, the link may be referred to as “good” or “up.” Typically, link loss is recognized at the physical level.

As illustrated in FIG. 1, server system 10 may be configured to automatically fail-over from NID 30a to NID 30b in response to link loss on downlink 60a, using technology such as HLB for example. Furthermore, as described in greater detail below, in accordance with the present disclosure, switch 40 may include a fail-over circuit 42 that automatically cuts off or disrupts downlink 60a, thereby triggering fail-over to switch 44.

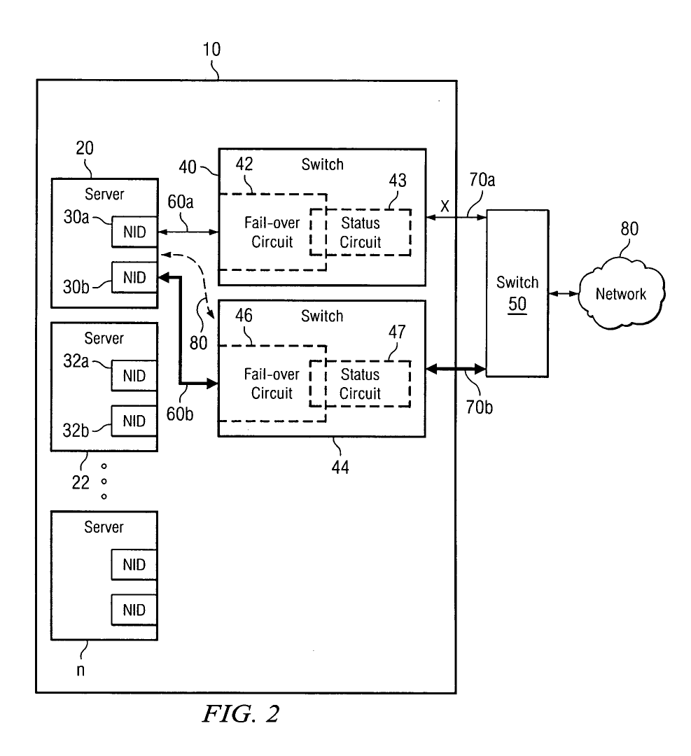

For example, with reference to FIG. 2, the “X” on uplink 70a represents failure of that communication path. As described in greater detail below, when switch 40 detects link loss on uplink 70a, fail-over circuit 42 automatically disrupts the communications on downlink 60, to trigger fail-over to switch 44, as indicated by the dashed, curved line 80 between downlink 60a and downlink 60b.

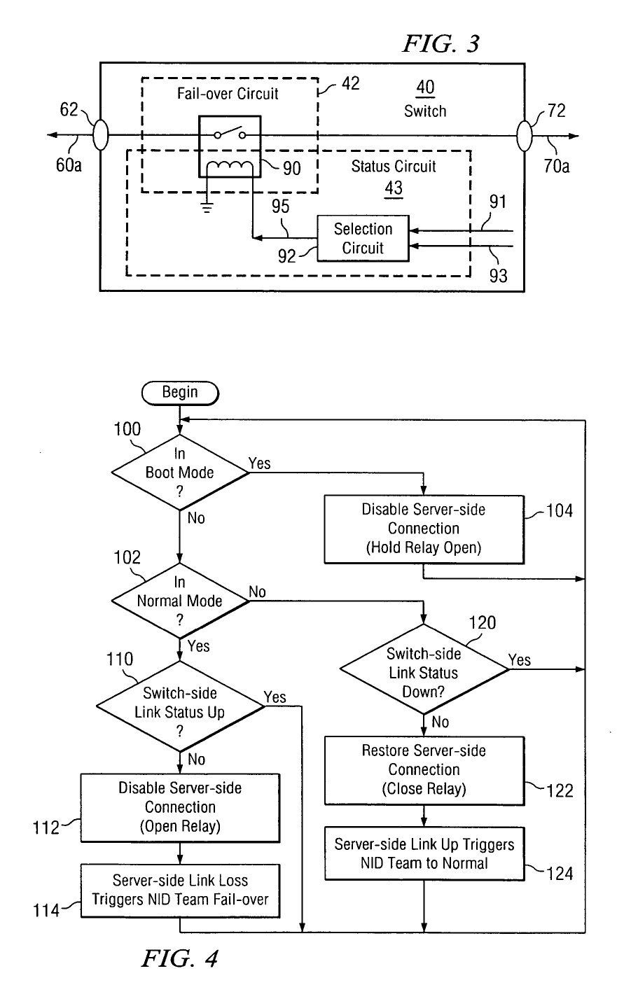

Referring now to FIG. 3, there is depicted a generalized schematic diagram of an example embodiment of switch 40 according to FIGS. 1 and 2. Depicted in switch 40 is a status circuit 43 that sends a status signal 95 to fail-over circuit 42. Status signal 95 typically indicates the link status of uplink 70a. Status signal 95 may also indicate whether switch 40 itself is in a boot process or has failed, for example because of loss of power or failure of a switch CPU. Status circuit 43 may thus detect both switch health status and the link status of switch-side ports. If any of these statuses goes wrong, status circuit 43 may control fail-over circuit 42 to open the circuits on the server-side ports, as described in greater detail below.

In the example embodiment, status signal 95 may be controlled by a selection circuit 92, based on inputs such as a link status signal 91 for switch-side port 72 and a mode selection signal 93. Selection circuit 92 may be implemented as a programmable logic device, and link status signal 91 may come from a circuit for a link LED signal, for example. One fail-over circuit 42 and one selection circuit 92 may be provided for each server-side port, for example.

Fail-over circuit 42 may be represented by a relay 90 that opens in response to conditions such as loss of the link signal in status circuit 43, thereby disrupting or disabling the relevant server-side port 62, in response to link loss on switch-side port 72. Fail-over circuit 42 may thus cause link loss on downlink 60a. In an example embodiment, fail-over circuit 42 is able to disable the server-side ports by opening the differential signal pairs of the server-side ports, and fail-over circuit 42 is able to enable the server-side ports by shorting the differential signal pairs of the server-side ports. Fail-over circuit 42 may be implemented as a high-speed fiber channel complementary metal oxide semiconductor (CMOS) switch. As described in greater detail below, disruption of the traffic between switch 40 and NID 30a preferably causes traffic to fail-over to switch 44. As described above, relay 90 may also open in response to conditions such as failure of switch 40.

In addition, as described below, selection circuit 92 may allow a vendor or user to disable fail-over circuit 42, so that switch 40 operates without some or all of the features disclosed herein for automatic fail-over. For instance, a user may set switch 40 to non-fail-over mode via a user interface. When selection circuit 92 has received a mode selection signal 93 representing such a selection, selection circuit 92 may cause fail-over circuit 42 to stay closed, so that conditions such as link loss on switch-side port and switch failure do not automatically cause link loss on server-side port 62. Alternatively, the user may set switch 40 to fail-over mode via the user interface. In response, switch 40 may provide automatic fail-over, as described herein.

As illustrated in FIGS. 1 and 2, switch 44 may include the same or similar circuits or features as those described above with regard to switch 40. For instance, switch 44 may includes a status circuit 47 and a fail-over circuit 46 to provide for automatic fail-over to switch 40 upon link loss on uplink 70b.

Referring now to FIG. 4, a flowchart depicts an example embodiment of a method for supporting automatic fail-over according to the present disclosure. The illustrated method begins with servers and switches connected and configured for fail-over, for instance as described above in connection with FIGS. 1-3. In particular, for purposes of illustration, the illustrated process will be described with regard to operations performed primarily by switch 40. The process in general, however, is not limited to the specific switch design or network architecture described above.

At block 100 in FIG. 4, switch 40 detects or determines whether switch 40 is currently in a boot process. If so, fail-over circuit 42 holds relay 90 open to disable downlink 60a, as shown at block 104. For instance, switch 40 may hold relay 90 open by causing status circuit 43 to indicate link loss. During switch rebooting, all switch ports may be unable to forward packets normally. So, during the switch rebooting, fail-over circuit 42 may hold the server-side ports open, to disable the server-side ports. This way of disabling the server-side ports may allow users to hot replace the failed switch without interrupting the running network traffic.

Switch 40 may hold relay 90 open for the duration of the boot process, as suggested by the arrow returning to block 100. Thus, fail-over circuit 42 may cause fail-over from switch 40 to switch 44 whenever switch 40 is being booted or rebooted, thereby avoiding disruption of traffic to and from server 20 during the boot process.

When switch 40 is not in boot mode, the process continues from block 100 to block 102, which shows switch 40 determining whether it is currently operating in normal mode or fail-over mode. If switch 40 is currently operating in normal mode, the process passes to block 110, which depicts switch 40 detecting whether uplink 70a is good. If that link is up, the process may simply return to block 100, with switch 40 supporting communication between switch-side port 72 and server-side port 62 as normal. However, if uplink 70a is down, switch 40 shifts from normal mode to fail-over mode, with relay 90 disabling server-side port 62, as shown at block 112. In response, server system 10 detects the link loss on downlink 60a and triggers NID team fail-over from NID 30a to NID 30b, as depicted at block 114. The process then returns to block 100.

However, referring again to block 102, if switch 40 is already in fail-over mode, the process passes from block 102 to block 120, and switch 40 detects whether or not uplink 70a is still down. If it is, switch 40 remains in fail-over mode and the process returns to block 100. On the other hand, if the connection has been restored on uplink 70a, status circuit 43 causes fail-over circuit 42 to close relay 90, thereby restoring downlink 60a and returning switch 40 to normal mode, as indicated at block 122. As depicted at block 124, the restoration of downlink 60a triggers server system 10 to return to normal, allowing NID 30a to resume operation.

The process may then return to block 100, with switch 40 reacting to subsequent conditions as appropriate to provide automatic fail-over, as described above. Switch 44 may operate in a similar manner, for instance to trigger automatic fail-over from downlink 60b to downlink 60a in response to loss of uplink 70b.

However, if selection circuit 92 is set to disable fail-over circuit 42, switch 40 may operate as a conventional switch. Switch 40 may therefore be configured as desired for a particular installation.

The disclosed embodiments may support real-time fail-over of a network switch, avoiding the latency associated the use of mechanisms like probe packets. The disclosed embodiments may also optimize the use of network bandwidth, since the systems may provide fail-over without transmitting data such as probe packets.

Although the disclosed embodiments have been described in detail, it should be understood that various changes, substitutions and alterations can be made to the embodiments without departing from their spirit and scope. For instance, in alternative embodiments, switch-side ports might be connected to devices other than switches. Furthermore, the invention is not limited to server systems with blade servers and blade switches, but pertains to any information handling system or method falling within the scope of the appended claims.

1. An information handling system with automatic fail-over capabilities for network communications, the information handling system comprising:
a first switch with a server-side port and a switch-side port, the server-side port in communication with a server;
a second switch in communication with the server;
a fail-over circuit in the first switch in communication with the server-side port; and
a status circuit in the first switch in communication with the fail-over circuit;
wherein the status circuit communicates link status of the switch-side port to the fail-over circuit;
wherein the fail-over circuit automatically disables the server-side port, in response to receiving a link status of down from the status circuit; and
wherein the second switch automatically takes over for the first switch, in response to disablement of the server-side port of the first switch, such that the first switch automatically fails over to the second switch in response to the link status of down on the switch-side port of the first switch.

2. The information handling system of claim 1, wherein the first switch automatically disables the server-side port substantially in real time.

3. The information handling system of claim 1, further comprising:
a server with a team of network interface devices (NIDS) in communication with the first and second switches, wherein the server automatically utilizes the second switch in lieu of the first switch, in response to disablement of the server-side port of the first switch.

4. The information handling system of claim 1, further comprising:
multiple server-side ports in the first and second switches.
multiple servers, each containing a team of network interface devices (NIDs) in communication with the first and second switches, wherein each team of NIDS automatically utilizes the second switch in lieu of the first switch, in response to disablement of the server-side ports of the first switch.

5. The information handling system of claim 1, further comprising:
a switch-side port in the first switch;
a switch-side port in the second switch; and
an external switch in communication with the switch-side ports in the first and second switches via respective first and second uplinks.

6. The information handling system of claim 5, wherein the fail-over circuit automatically disables the server-side port, in response to failure of the first uplink.

7. A network switch with automatic fail-over capabilities for network communications, the network switch comprising:
a switch-side port;
a server-side port;
a fail-over circuit in communication with the server-side port; and
a status circuit in communication with the fail-over circuit;
wherein the status circuit communicates link status of the switch-side port to the fail-over circuit; and
wherein the fail-over circuit automatically disables the server-side port, in response to receiving a link status of down for the switch-side port from the status circuit.

8. The network switch of claim 7 further comprising:
a selection circuit in communication with the fail-over circuit, wherein the selection circuit, when activated, prevents the fail-over circuit from disabling the server-side port in response to receiving a link status of down for the switch-side port.

9. The network switch of claim 7, wherein:
the fail-over circuit automatically enables the server-side port, in response to receiving a link status of up for the switch-side port from the status circuit.

10. The network switch of claim 7, further comprising multiple server-side ports.

11. The network switch of claim 10, further comprising multiple fail-over circuits that automatically disable the multiple server-side ports in response to receiving a link status of down for the switch-side port.

12. A method of providing automatic fail-over between switches in a network, the method comprising:
monitoring link status of a switch-side port of a switch;
in response to detecting a link status of down on the switch-side port, automatically disabling a server-side port of the switch.

13. The method of claim 12, wherein the operation of automatically disabling the server-side port comprises:
automatically disabling the server-side port in substantially real-time.

14. The method of claim 12, wherein the operation of automatically disabling the server-side port comprises:
automatically triggering a fail-over circuit in the switch to disable the server-side port.

15. The method of claim 12, further comprising:
after automatically disabling the server-side port, continuing to monitor the link status of the switch-side port of the switch;
in response to detecting a link status of up on the switch-side port of the switch, automatically restoring the server-side port of the switch.

16. The method of claim 12, wherein the switch comprises a first switch in the network, the method further comprising:
monitoring link status of the server-side port of the first switch; and
in response to detecting the link status of down on the server-side port of the first switch, automatically failing over from the first switch to the second switch.

17. The method of claim 16, further comprising:
after automatically disabling the server-side port of the first switch, continuing to monitor the link status of the switch-side port of the first switch;
in response to detecting the link status of up on the switch-side port of the first switch, automatically restoring the server-side port of the first switch.

18. The method of claim 17, further comprising:
in response to detecting the link status of up on the server-side port of the first switch, automatically resuming communication with the first switch.

19. The method of claim 12, further comprising automatically disabling a server-side port of the switch during a boot process of the switch.

20. The method of claim 12, further comprising automatically disabling a server-side port of the switch in response to failure of the switch.
